(19) United States
(12) Patent Application Publication
(10) Pub. No.: US 2008/0001930 A1
(43) Pub. Date: Jan. 3, 2008

(54) An Improved Stylus for PDA or other Digitizing Screen or Tablet

(76) Inventor: Catherine Sue Hawkins, Riverside, CA (US)

Correspondence Address: CATHERINE SUE HAWKINS, 3365 SPRING GARDEN STREET, RIVERSIDE, CA, 92501-1947, US

(21) Appl. No.: 11/420,149

(22) Filed: May 24, 2006

(51) Int. Cl. G06F 3/033

(52) U.S. Cl. 345/179

(57) ABSTRACT

What is presented here is an improved writing stylus (“No Mar” Stylus) for use with a personal digital assistance device or other such device with a digitizing screen or tablet. Being constructed entirely of a softwood material, being shaped to a rounded point at the tip, the softwood, having itself has a type of protective cellular structure and composition to enable the “No Mar” Stylus to interface with the writing digitizer pad or tablet without leaving any permanent scarring, indelible mark or build-up on the screen interface of the digitizing writing screen or tablet.

### CROSS-REFERENCE TO RELATED APPLICATIONS

References Cited

U.S. Patent Documents
U.S. Patent Documents

| | | |
|---|---|---|
| 606681 | May 23, 2000 | Heilman, III |
| 679937 | Oct. 5, 2004 | Schopfet al |
| 662659 | Sep. 30, 2003 | Schneider |
| 587745 | Mar. 2, 1999 | Prater |
| 415874 | Jun. 19, 1979 | Muller et al. |
| 704623 | May 16, 2006 | Blacklock |
| 691459 | Jul. 5, 2005 | Liu et al |
| 563568 | Jun. 3, 1997 | Cherdak et al |
| 544008 | Aug. 8, 1995 | Nagaoka et al |
| 469705 | Sep. 29, 1987 | Farel at al |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to wireless stylus used to input information into a Personal Data Assistant or other such device with a digitizing writing tablet or screen. In particular, it relates to the improvement of the stylus and material its composed of and the relation of same as it relates to the continued quality of use of PDAs and other such digitizing tablets which interface using writing digitizer stylus. By using this “No Mar” stylus described herein, it will considerably lengthen the usefulness of the digitizing screens used as well as provide an ecologically compatible alternative and reduced cost by prolonging the life use of these screens, as the softwood from which it is constructed will show significant reduction of scratching, marring or other damage of the digitizing writing tablet or screen.

2. Description of the Background Art

As we delve into the 21^{st} century, there are so many more methods available to people to assist them in their daily lives as well as their business dealings. More and more people are relying on the plethora of palm-sized computers, personal data/digital assistants to organize, plan and move through their lives at home and at work. Artists now have such devices more readily available to them enabling them to work just about anywhere with little more than a stylus and a PDA or other form of digitizing tablet which can save work done on computers within them.

One of the most important parts of these digitizing screens, tables and such is the very sensitive, thin, pliable and transparent overlay used to detect the relationship between the pen/stylus and the screen. As the stylus slides over or taps on this layer, information is translated to the circuitry below the screen providing an image or representation according to the program being used by the hand-held computer at that time.

With prior art, after much use, this layer becomes damaged, scratched, and/or marred. Occasionally the damage is so severely as to render stylus input to the screen either impossible or severely distorted. In many instances, it may lead to a required replacement of the input screen. SONY, manufacturing their PDA, “Clie®” does not cover the screen of any PDA under initial or any other warranty. Damaged screens can result in lost data, inability to obtain data when needed. BELKIN, one among many, has manufactured transparent screen overlays to protect this sensitive, pliable screen. Many different types of materials have been tried in the search to produce a more scratch resistant screen, and improvements to the stylus used to lessen this inevitable damage.

Still, there is a need for an improved writing digitizer stylus for inputting the data which will result in less friction and wear of the digitizing input screen as the stylus tip continually moves over, taps on or otherwise contacts said screen.

### BRIEF SUMMARY OF THE INVENTION

It is therefore the object of this invention to provide a “No Mar” Stylus made simply of a solid piece of softwood, still intact. The softwood's cellular structure is more pliable than hardwood. And it, as a solid piece of softwood, it will still contain all of the natural structures which will allow it to significantly reduce the friction apparent in prior art which cause such damage, scratching and marring as the PDA or graphic tablet being used. The self-lubricating nature of the softwood allows the stylus to move over the input screen with considerably more ease and smoothness than any previous material used for digitizing stylus for writing digitizer pads, tablets or screens to date. The consequence of this is that the softwood “No Mar” stylus presented here will have far less, if any damage apparent on these digitizing input screens.

### DETAILED DESCRIPTION OF THE INVENTION

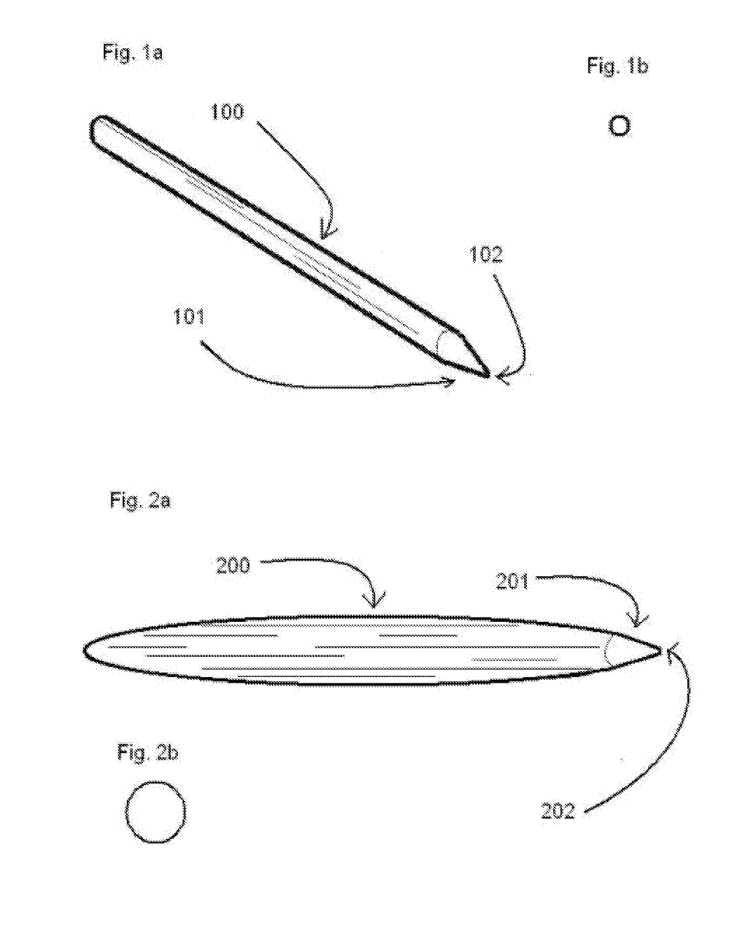

FIG. 1 depicts this improved writing stylus where a piece of solid softwood is carved into a conventional stylus shape suitable to fit inside the receptacle of a PDA such as Sony's CLIE®.

FIG. 2 depicts another design for the “No Mar” stylus from a solid piece of softwood carved into a more conventional looking writing instrument such as a pen.

The softwood “No Mar” stylus includes, but is not limited to, a solid piece of softwood carved by CNC Machining, into an elongated cylindrical barrel as a body section and head section made of the same piece of softwood from Conifer species such as Pinus strobus, Cupressus arizonica, or Thuja occidentalis or other softwood species of Conifers.

FIG. 1 depicts an improved digitizing writing stylus.

In this present invention, FIG. 1a shows the “No Mar” stylus writing device as it would be capable to fit into a receptacle of a PDA stylus slot. The writing instrument comprises a solid, elongated, cylindrical barrel 100, which changes at one end into a conical shaped head portion 101, which tapers into a small diameter rounded point at its tip 102. The entire stylus is carved from a single piece of softwood via CNC Machining. FIG. 1b shows a representation of the diameter of this “No Mar” stylus. The actual diameter would be CNC machined according to the specifications of the various sizes of stylus accompanying a PDA sold on the market today.

FIG. 2 depicts an improved digitizing writing stylus CNC machined into one such design to be able to be used as with the ease of a good pen or other such writing instrument. However, it is composed, as well, of only one piece of softwood with an elongated cylindrical shaped body 200, narrowing to a conical shaped head section 201, which comes to a narrow diameter, soft rounded point at its tip 202. An approximate diameter is shown in FIG. 2b. This writing digitizing stylus can be carried and handles as comfortable as a pen. This design is only one of many which may embody the salient points of this invention to be used as a stylus.

Other designers and marketers of these types of stylus would be able to make a variety of designs and forms using the guidelines and specifications of this invention as claimed herein.

1. An improved stylus made of all softwood, “No Mar” stylus, for use with a pen-based computing device having writing digitizer screen or tablet for inputting data into a PDA device or other such digitizing writing tablets

2. The nature of the softwood, claim 1, considerably reduces the scratching or marring or other such damage of the input screen of any pen-based data input device.

3. The wood “No Mar” stylus, claim 1, includes, but is not limited to, a solid piece of softwood carved into an elongated cylindrical barrel as a body section and head section, conical in shape coming to a soft, rounded point at its tip.

4. (canceled)

5. The stylus, according to claim 1, wherein the stylus is crafted from a single piece of softwood selected from such woods classified as softwood from Conifer species such as pine, Pinus, cypress, Cupressus, or cedar, Thuja

6. (canceled)

7. The Stylus, according to claim 1, wherein wood “No Mar” stylus is formed from softwood, to have a cylindrical shape tapering to conical shape at the head by CNC Machining (Computerized Numerical Controlled Machining).

8. The softwoods with which this Stylus is to be made have, as is their nature, a lesser hardness than other types of wood because ‘softwoods’ have only two types of cells for transport of fluids within the cambium layer and they form a simpler, more uniform structure. This allows the stylus tip to glide more easily across the digitizing input screen.

9. Softwood products, noted in claim 5, also have a waxy component inherent within their cellular structure which will reduce the friction between the point of the head of the “No Mar” Stylus and the surface of the pen-based data input screen or tablet.

10. (canceled)

11. Passive stylus configured to input information into a PDA or other such writing digitizer Pad/tablet without causing scratches or other types of damage which would severely limit the productive life of said pad/tablet's screen interface.

12. The “No Mar” stylus can be crafted to conform to the specifications which would allow it to be carried in that same receptacle on PDAs marketed today which is formed as part of the PDA to carry the manufacturer's stylus.
